(19) United States
(12) Patent Application Publication
(10) Pub. No.: US 2025/0306989 A1
(43) Pub. Date: Oct. 2, 2025

(54) PROCESSOR INCLUDING MATRIX SCHEDULER AND INFORMATION PROCESSING DEVICE

(71) Applicants: Fujitsu Limited, Kawasaki-shi (JP); The University of Tokyo, Tokyo (JP); Inter-University Research Institute Corporation Research Organization of Information and Systems, Tokyo (JP)

(72) Inventors: Ryota Shioya, Bunkyo (JP); Toru Koizumi, Bunkyo (JP); Masahiro Goshima, Chiyoda (JP); Yi Ge, Bunkyo (JP)

(73) Assignees: Fujitsu Limited, Kawasaki-shi (JP); The University of Tokyo, Tokyo (JP); Inter-University Research Institute Corporation Research Organization of Information and Systems, Tokyo (JP)

(21) Appl. No.: 19/065,439

(22) Filed: Feb. 27, 2025

(30) Foreign Application Priority Data
Mar. 29, 2024 (JP) 2024-057061

(51) Int. Cl. G06F 9/48; G06F 1/329

(52) U.S. Cl. CPC G06F 9/4881; G06F 1/329

(57) ABSTRACT

A processor includes a matrix scheduler, wherein the matrix scheduler includes a first latency selector disposed on an input side of each column corresponding to a producer in a matrix; and a second latency selector disposed on an output side of each row corresponding to a consumer in the matrix, and the matrix scheduler is configured to carry out wakeup operation at a latency being a sum of a latency of the first latency selector and a latency of the second latency selector on a wakeup signal path passing through the first latency selector and further passing through the second latency selector.

### CROSS-REFERENCE TO RELATED APPLICATION

This application is based upon and claims the benefit of priority of the prior Japanese Patent application No. 2024-057061, filed on Mar. 29, 2024, the entire contents of which are incorporated herein by reference.

### FIELD

The embodiment discussed herein relates to a processor including a matrix scheduler and an information processing device.

### BACKGROUND

In a general-purpose processor core, the latencies of executing units which execute instructions differ depending on their types. The latency of an ALU (Arithmetic Logic Unit) which executes basic integer instructions is 1τ (cycle). On the other hand, the latency of an FMA (Fused Multiply-Add) unit which executes floating-point multiply-add operation instructions is as long as about 5τ.

Even for an instruction executed in an executing unit with a long latency, which means the instruction having that long latency, an out-of-order (OoO) core can hide the latency and maintain a high throughput by executing one or more instructions not having dependency with the long-latency instruction. However, this OoO scheduling requires a lot of computational resources proportional to the lengths of these latencies. For the above, it is still important to shorten the latencies.

To shorten the latencies, in addition to circuit-level efforts, an architectural approach is important which effectively shortens the latency under a certain condition. For example, in an FMA unit that calculates rL1×rL2+rS1, the source operand rs1, which is used for the first time in the addition subsequent to the multiplication rL1×rL2, and thus can be inputted later than rL1 and rL2. By using this, the latency can be effectively shortened, for example, when the cumulative sum rs1=rL1×rL2+rS1 is performed.

However, in this case, the latency of the source operand rs1 from the input is different from the latencies of the source operands rL1 and rL2 from the input. As in this example, a single executing unit having operands different in latency is referred to as a “heterogeneous-latency executing unit”.

For example, a related example is disclosed in US Patent Application Publication No. 2016/0179552.

### SUMMARY

As one aspect, a processor includes a matrix scheduler, wherein the matrix scheduler includes a first latency selector disposed on an input side of each column corresponding to a producer in a matrix; and a second latency selector disposed on an output side of each row corresponding to a consumer in the matrix, and the matrix scheduler is configured to carry out wakeup operation at a latency being a sum of a latency of the first latency selector and a latency of the second latency selector on a wakeup signal path passing through the first latency selector and further passing through the second latency selector.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram schematically illustrating a configuration of a processor core;

FIG. 2 is a diagram illustrating an example of a configuration of an FMA unit according to a related example;

FIG. 3 is a block diagram schematically illustrating an example of making the latencies of an FMA unit heterogeneous according to the related example;

FIG. 4 is a diagram illustrating examples of a configuration of the stages of an FMA unit with a homogeneous latency and an FMA unit with heterogeneous latencies in the related example;

FIG. 5 is a diagram illustrating executing units with homogeneous latencies and executing units with heterogeneous latencies of the related example;

FIG. 6 is a diagram illustrating an example of instruction scheduling for heterogeneous latencies of the related example;

FIG. 7 is a diagram illustrating a first example of a matrix scheduler of the related example;

FIG. 8 is a diagram illustrating a second example of a matrix scheduler of the related example;

FIG. 9 is a diagram illustrating an example of a matrix scheduler having two or more executing units with different homogeneous latencies;

FIG. 10 is a diagram illustrating a problem of a conventional matrix scheduler to deal with heterogeneous latencies in the related example;

FIG. 11 is a table illustrating homogeneous and heterogeneous latencies in the related example;

FIG. 12 is a diagram illustrating an example of a matrix scheduler of a multi-column scheme according to an embodiment;

FIG. 13 is a diagram illustrating an example of a matrix scheduler of a multi-bank scheme according to the embodiment;

FIG. 14 is a diagram illustrating an example of a matrix scheduler of a single-column scheme according to the embodiment;

FIG. 15 is a diagram illustrating an example of a latency selector;

FIG. 16 is a diagram illustrating a hazard of a p-WLT entry; and

FIG. 17 is a diagram illustrating a design of the state machine of a p-WLT entry.

### DESCRIPTION OF EMBODIMENT(S)

In an OoO core, a circuit that determines issuing an instruction to an executing unit is referred to as an instruction scheduler.

A conventional scheduler does not assume a heterogeneous-latency executing unit. In particular, it is not easy to adapt a matrix scheduler, which is one of the most efficient implementation schemes, to a heterogeneous-latency executing unit.

### (A) Related Example

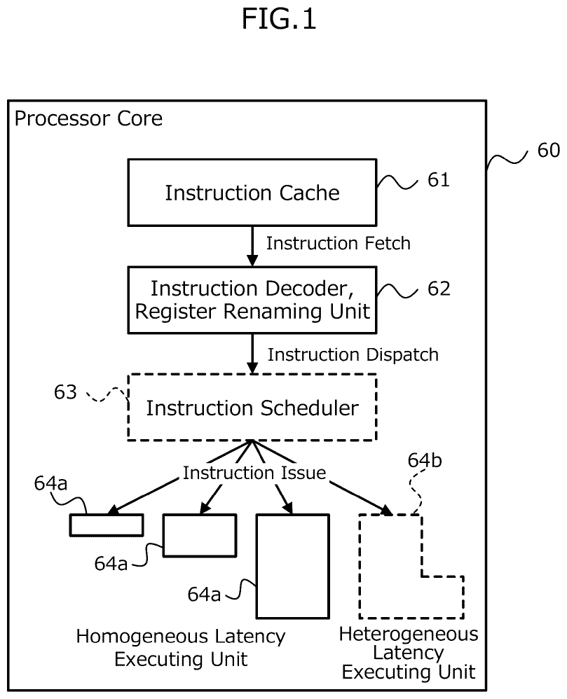

FIG. 1 is a diagram schematically illustrating a configuration of a processor core 60.

The processor core 60 is an out-of-order (OoO) core that can simultaneously execute multiple instructions in an OoO fashion, and includes an instruction cache 61, an instruction decoder and register renaming unit 62, an instruction scheduler 63, homogeneous-latency executing units 64a, and a heterogeneous-latency executing unit 64b.

An instruction fetched from the instruction cache 61 is sent to the instruction decoder and register renaming unit 62.

An instruction that has been subjected to decoding and register renaming in the instruction decoder and register renaming unit 62 is dispatched to the instruction scheduler 63.

The instruction scheduler 63 is, for example, a matrix scheduler, and issues instructions to the homogeneous-latency executing units 64a and the heterogeneous-latency executing unit 64b.

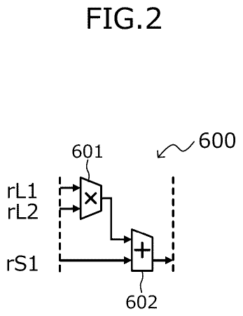

FIG. 2 is a block diagram schematically illustrating a circuit configuration of a floating-point FMA (Fused Multiply-Add) unit of a related example.

An FMA unit 600 illustrated in FIG. 2 executes the FMA instruction rL1×rL2+rS1.

An FMA instruction executed by the FMA unit 600 may double the floating-point performance (FLOPS) per instruction as compared with separately executing a multiplication instruction by the multiplier 601 and an addition instruction by the adder 602. A recent high-performance general-purpose processor can execute two or more (SIMD) FMA instructions per cycle.

An FMA instruction has a long latency. (Latency of the entire instruction)≈(latency of multiplication)+(latency of addition) holds. In a processor of a supercomputer, the FMA latency can be as long as 9τ.

In order to achieve a high throughput, a large number of instructions need to be executed in parallel to hide such a long latency, and computational resources proportional to the latency are consumed. The computational resources to be consumed include the entries of the instruction scheduler and the physical register files.

Therefore, if the latency can be reduced, equivalent performance can be achieved with a smaller-scale core with less computational resources.

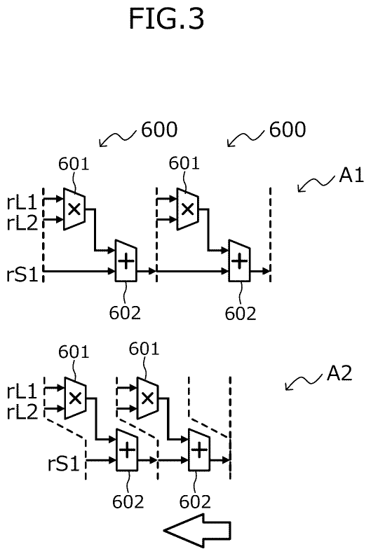

FIG. 3 is a block diagram schematically illustrating an example of making the latencies of an FMA instruction heterogeneous according to the related example.

The cumulative sum, which receives the results of a preceding FMA instruction by the addend rS1 (rather than the multiplicand rL1 and multiplier rL2), frequently appears in scientific computation, such as an inner product of matrices or vectors.

For the cumulative sum, a lower latency can be achieved by shortening the latency of the addend rs1 as indicated by the reference sign A2 from a state where the floating-point FMA units 600 are simply used in two stages as illustrated by the reference sign A1. The latency of a single FMA instruction can typically be shortened from (latency of multiplication)+(latency of addition) to (latency of addition).

This case makes the latencies on the source side of the FMA instruction heterogeneous, which means the latency from rs1 is shorter than that from rL1 and rL2. The operands rL1, rL2 are called long-latency source operands, and the operand rs1 is called a short-latency source operand.

Although the following description will be made on the basis of two types of long and short latencies, but the same holds true for three or more types.

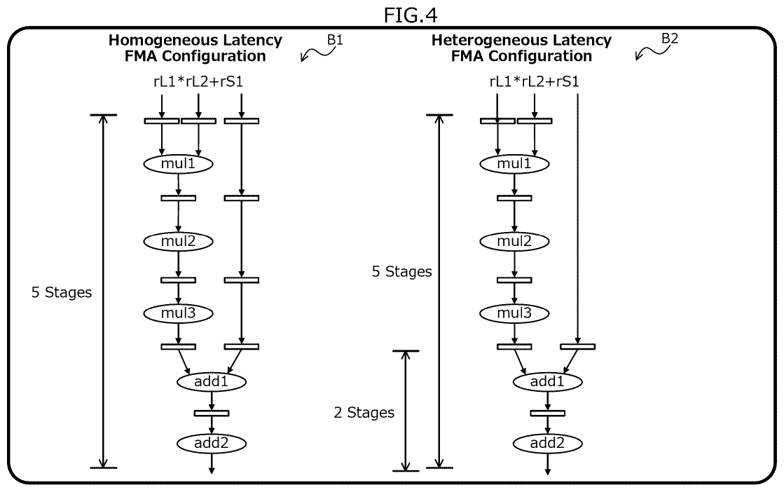

FIG. 4 is a diagram illustrating examples of configurations of stages of an FMA unit with a homogeneous latency and an FMA unit with heterogeneous latencies in the related example. In FIG. 4, the term “mul” represents multiplication stages and the term “add” represents addition stages.

In the FMA with a homogeneous latency indicated by the reference sign B1, all the source operands rL1, rL2, and rs1 have the same number of stages from the input.

In other words, the number of stages of all the source operands from all the respective inputs to the outputs are uniform, and in the example indicated by the reference sign B1, the latency in cycles is 5.

In the FMA with heterogeneous latencies indicated by the reference sign B2, the source operand rs1 has a smaller number of stages from the input than those of the source operands rL1 and rL2.

In the example indicated by the reference sign B2, the latency is 5 from the source operands rL1 and rL2 and the latency is 2 from the source operand rS1.

Therefore, in this case, the latency of the FMA unit can be reduced from 5 to 2 when a cumulative sum is calculated.

The example of the FMA unit illustrated in FIG. 4 has two types of latency, i.e., long and short, but the same holds true for three or more types.

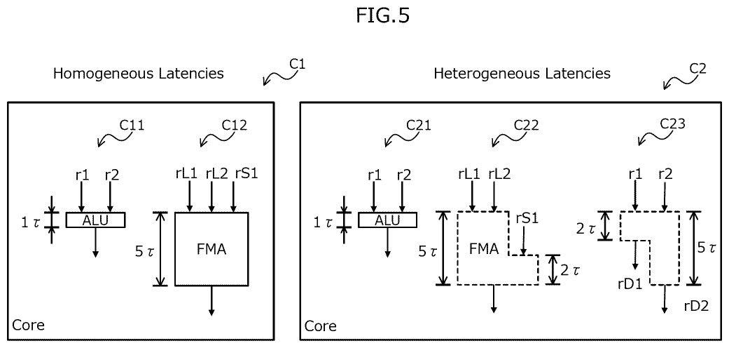

FIG. 5 is a diagram illustrating processor cores including executing units with homogeneous latencies and executing units with a homogeneous latency and heterogeneous latencies of the related example.

The homogeneous-latency core indicated by the reference sign C1 is provided with multiple executing units each of which has uniform but different latencies one another. For example, as indicated by the reference sign C12, the latency of the ALU is 1 τ as indicated by the reference sign C11, but the latency of the FMA is 5τ.

In the heterogeneous-latency core illustrated in the reference sign C2, one or more execution units have heterogeneous latencies. As indicated by the reference sign C21, the latency of the ALU is 1 τ as with the homogeneous-latency core. As indicated by the reference sign C22, in an FMA unit where the input-side is uneven, the latency of rL1 and rL2 are 5 τ and the latency of rS1 is 2 τ . As indicated by the reference sign C23, an execution unit having multiple output-side destinations in the latency of 2 τ for rD1 and the latency of 5 τ for rD2.

As example in which the input-side latencies are different, in an FMA unit, the input of the addend can be delayed from that of the multiplicand and multiplier, as described before. For another example, in a store instruction, the input of the store value can be delayed from that of the store address.

As an example in which the latencies for an output-side are different, for a CMP (comparing) instruction, the latencies can be different between the predicate register and the flag register.

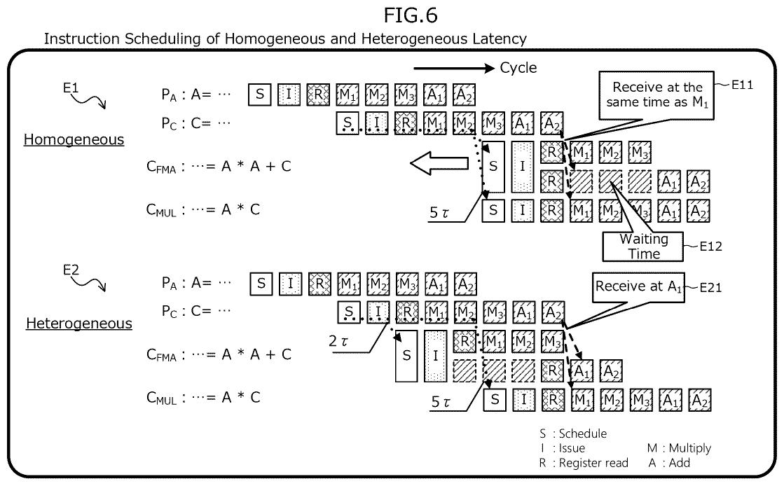

FIG. 6 is a diagram illustrating a first example of scheduling of instructions with heterogeneous latencies of the related example.

An instruction scheduling consists of the loop of wakeup and select phases. In the select phase, zero or more instructions are selected to be issued from the set of ready instructions. When the result of an instruction is used by another instruction, the former and the latter are referred to as the producer and the consumer. When a producer is selected in the select phase, in the subsequent wakeup phase, the source operands of the consumers that receive the result of the producer are set ready after an appropriate wakeup latency. A consumer instruction that has all the source operands set ready is woken up to be ready. Then, in the subsequent select phase, zero or more instructions are selected to be issued from the updated set of ready instructions.

In the instruction scheduling of the homogeneous latency indicated by the reference sign E1, as indicated by the reference sign E11, the execution result C of the producer P_{C}, which is however required at the Add stage A₁ for the first time, is passed at the same time as the starting timing of the Multiply stage M₁. Consequently, as indicated by reference sign E12, a waiting time occurs until the stage A₁.

On the other hand, in the instruction scheduling of the heterogeneous latencies indicated by the reference sign E2, as indicated by the reference sign E21, the execution result C is passed at the stage A₁ in which the execution result C is actually required. This makes it possible to shorten the scheduling latency from the P_{C} to the C_{FMA} from 5 τ to 2 τ.

However, for this purpose, if a consumer C_{MUL} that receives C as a long-latency source operand is present in addition to the C_{FMA}, the P_{C} needs to selectively use two types of scheduling latencies of 2 τ and 5 τ for the C_{FMA} and the C_{MUL}, respectively.

In the conventional instruction scheduling of the homogeneous latency, it is adequate to use only one type, 5 τ, of a scheduling latency which is determined by the latency of the execution unit of the producer P_{C} itself.

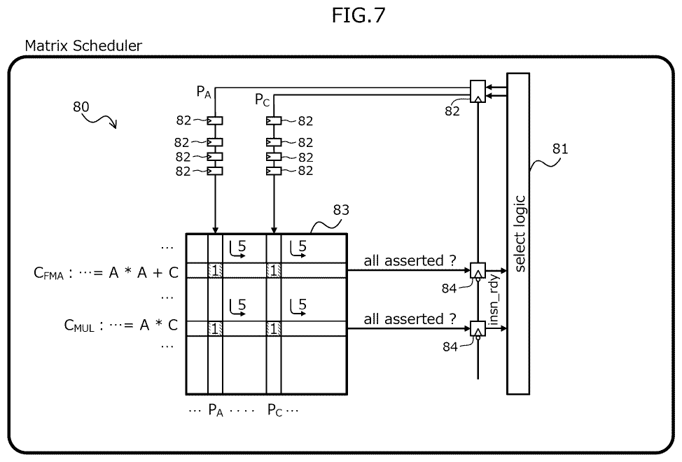

FIG. 7 is a diagram illustrating a first example of a matrix scheduler 80 in the related example.

The matrix scheduler 80 includes a select logic 81, multi-stage FFs (Flip-Flops) 82, a matrix 83, and multiple negative-edge-triggered FFs 84. The loop consisting of these elements is one of the most timing-critical paths in the core. Alternatively, among the FFs 82 and the FFs 84, the FFs 82 may be of negative-edge-triggered and the FFs 84 may be of positive-edge-triggered.

In the matrix scheduler 80, the output of select logic 81 is inputted into a one-stage FF 82, and multiple stages of FFs 82 (four stages in the example illustrated in FIG. 7). The outputs of the multiple stages of FFs 82 are inputted into the matrix 83 and the outputs from matrix 83 are inputted into the negative-edge-triggered FFs 84. The outputs of the negative-edge-triggered FFs 84 are inputted into the select logic 81.

In the matrix scheduler 80, wakeup operation is carried out in the matrix 83, which represents dependencies between instructions. In the matrix 83, the columns and the rows correspond to the producers and the consumers, respectively. The ID for identifying a producer or a consumer may be the instruction number, the register number of the assigned physical register, or source operands, or the like. In the example illustrated in FIG. 7, a column and a row corresponds to an instruction number.

When a consumer is dispatched to a row, the elements of the columns corresponding to its producers are set to 1.

When a producer is selected, the corresponding column is asserted after the appropriate latency. Multiple columns may be asserted at the same time.

The consumer of a row where all the columns set to 1 are asserted comes ready.

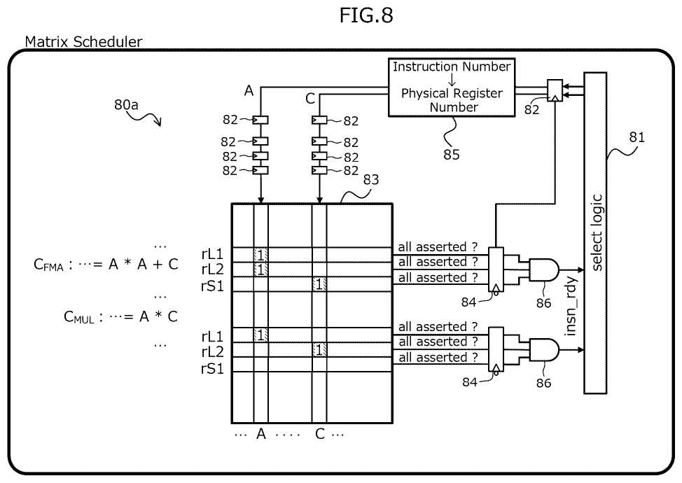

FIG. 8 is a diagram illustrating a second example of a matrix scheduler 80a in the related example.

In the example of FIG. 8, unlike the example of FIG. 7, the matrix scheduler 80a includes a converter 85 that converts an instruction number into a physical register number between the FF 82 downstream of the select logic 81 and the multiple stages of the FFs 82. The matrix scheduler 80a further includes a AND gate 86 between the respective negative-edge-triggered FF 84 and the select logic 81.

In the matrix scheduler 80a, wakeup operation is performed in the matrix 83, which represents dependencies between instructions via physical registers assigned to the instructions. In the example illustrated in FIG. 8, a column corresponds to the physical register allocated to the destination of the producer, and the row corresponds to each of the source operands of the consumer.

When a consumer is dispatched, the element of the column of the physical register allocated to each of the source operands is set to 1.

When a producer is selected, the corresponding column is asserted (multiple columns may be asserted at the same time) after the appropriate latency.

A consumer whose columns being 1 for all the source operands are asserted comes ready.

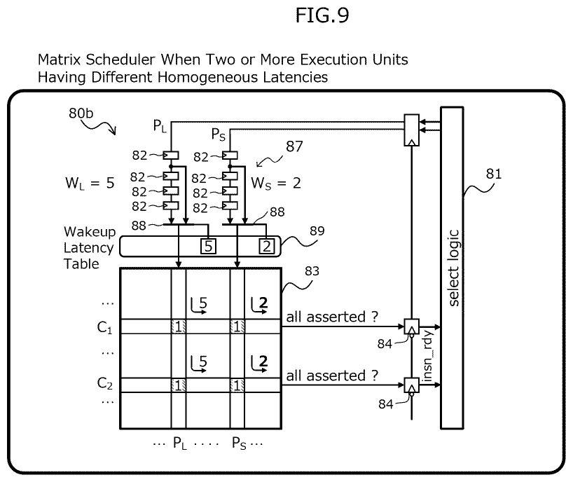

FIG. 9 is a diagram illustrating an example of a matrix scheduler 80b including two or more executing units having different homogeneous latencies. Even with homogeneous latency, other producers may have different latencies. Since, after a certain producer finishes use of a certain column, another producer reuses the same column, the column has respective different latencies (at different times).

In the example of FIG. 9, unlike the example of FIG. 7, the matrix scheduler 80b includes, as a latency selector 87, multiple stages of FFs 82 and a selector 88 downstream of the FFs 82.

A scheduling latency is achieved by additionally providing a latency selector 87 on the input-side of a column (producer) and adjusting the latency of the wakeup operation. The latency is specified by an entry in a Wakeup Latency Table 89.

Even in this case, the wakeup latency is unique to each producer and one producer is not allowed to use two schedule latencies at the same time.

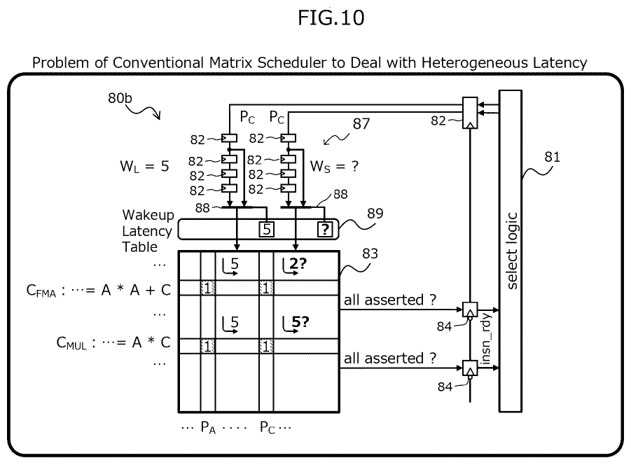

FIG. 10 is a diagram illustrating a problem of a conventional matrix scheduler to deal with heterogeneous latencies in the related example.

In the heterogeneous latencies, one instruction (P_{C}) has to use different wakeup latencies (W_{L} or W_{S} being 5 and 2, respectively) for respective consumers (i.e., C_{MUL} and C_{FMA}, respectively).

However, the latency selector 87 for each column (P_{C}) is incapable of dealing with both C_{MUL} (W_{L}=5) and C_{FMA} (W_{S}=2) at the same time, as illustrated in FIG. 10.

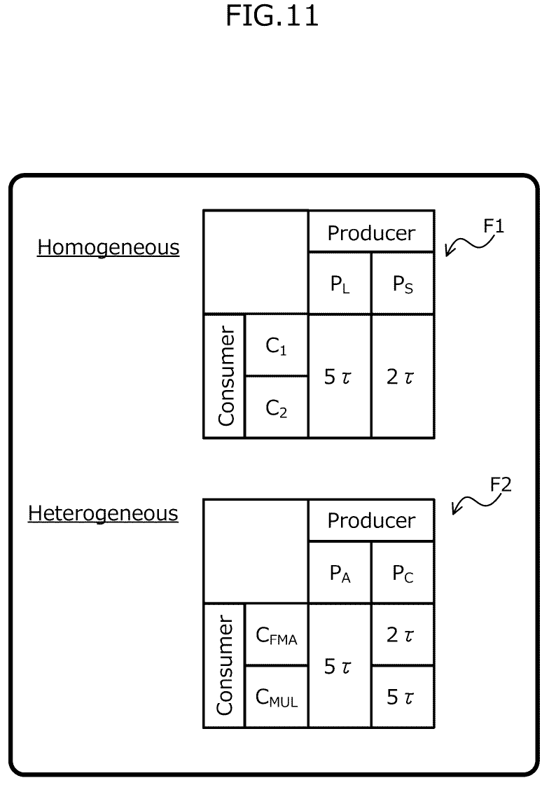

FIG. 11 shows tables illustrating a homogeneous latency and heterogeneous latencies in the related example.

As illustrated in the reference number F1, the wakeup latency of a homogeneous latency is always unique to each individual producer.

As illustrated in the reference sign F2, the wakeup latency of heterogeneous latencies may vary with each individual consumer.

### (B) Embodiment

Hereinafter, an embodiment will now be described with reference to the accompanying drawings. However, the following embodiment is merely illustrative and is not intended to exclude the application of various modifications and techniques not explicitly described in the embodiment. Namely, the present embodiment can be variously modified and implemented without departing from the scope thereof. Further, each of the drawings can include additional functions not illustrated therein to the elements illustrated in the drawing.

Hereinafter, throughout the drawings, like reference numbers designate the same or similar elements, so repetitious description is omitted here.

### (B-1) Example of Configuration

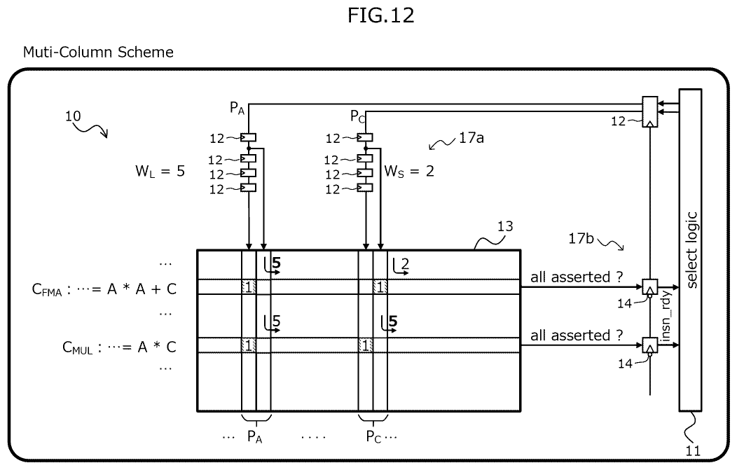

FIG. 12 is a diagram illustrating an example of the configuration of a matrix scheduler 10 of the multi-column scheme according to the embodiment.

The matrix scheduler 10 includes a select logic 11, multiple FFs (Flip-Flops) 12, a matrix 13, and multiple negative-edge-triggered FFs 14.

In the matrix scheduler 10, the output of the select logic 11 is inputted into a one-stage FF 12, and multi-stage (four stages in the example illustrated in FIG. 12) of FFs 12. The outputs of the multi-stage FFs 12 are inputted into multiple columns of the matrix 13 (in the example illustrated in FIG. 12, four columns in total consisting of a pair of two columns from P_{A} and a pair of two columns from P_{C} are emphasized). The outputs from the matrix 13 are inputted to the negative-edge-triggered FFs 14 and the outputs from the negative-edge-triggered FFs 14 are inputted into the select logic 11.

In the example illustrated in FIG. 12, a column is provided for each of heterogeneous latencies. A signal is extracted from the middle stage of the multi-stage FFs12 (from the first stage in the example illustrated in FIG. 12) and inputted into the right column of each pair. As a result, the wakeup latencies can be completely specified. When viewed from P_{C}, the value 1 is set in the right of the pair for C_{FMA} and also in the left of the pair for C_{MUL}, which can carry out wakeup operation at the latencies of W_{S}=2 and W_{L}=5, respectively. In this way, though the latency can be completely specified, the width of the matrix is doubled (more precisely, proportional to the number of types of the latencies).

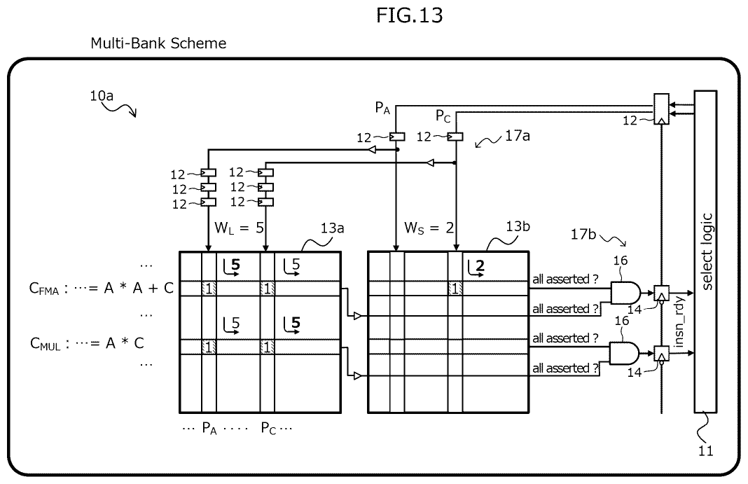

FIG. 13 is a diagram illustrating an example of a matrix scheduler 10a of a multi-bank scheme according to the embodiment.

In the example illustrated in FIG. 13, unlike the example illustrated in FIG. 12, the matrix scheduler 10a includes multiple (two in the example of FIG. 13) matrices 13a and 13b, and multi-input (two-input in the example of FIG. 13) AND gates 16.

The outputs of the one-stage FFs 12 are inputted into the matrix 13b, and the outputs of the four-stage FFs12 are inputted into the matrix 13a. As a result, the wakeup latency to the matrix 13a is W_{L}=5, and the wakeup latency to matrix 13b is W_{S}=2.

The outputs of the matrices 13a and 13b are inputted into the AND gates 16 and the outputs of the AND gates 16 are inputted into the negative-edge-triggered FFs 14.

In the example illustrated in FIG. 13, the matrix is “multi-banked” into separate matrices for each of heterogeneous latencies. This multi-banking facilitates optimization of the circuit delay. Increase of a delay in the matrix 13b on the right side, which is more critical, can only be limited to fan-out increase on the input side and the AND gates 16 on the output side.

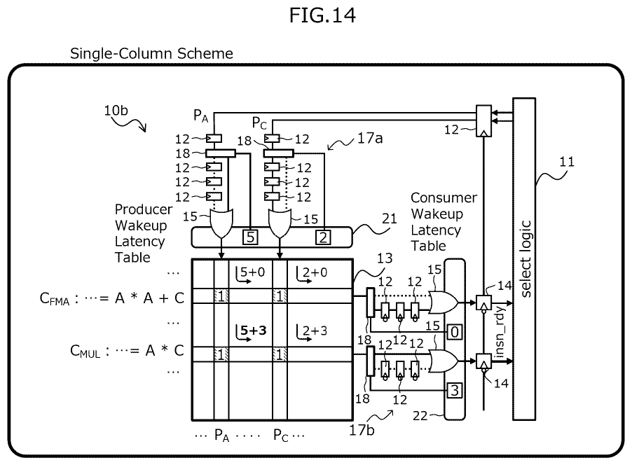

FIG. 14 is a diagram illustrating an example of a matrix scheduler of a single-column scheme according to the embodiment.

In the example illustrated in FIG. 14, unlike the example illustrated in FIG. 12, the matrix scheduler 10b includes, on the input side of the matrix 13, multi-stage (four stages in the example illustrated in FIG. 14) FFs 12, decoders 18, OR gates 15, and a Producer Wakeup Latency Table 21. Further, the matrix scheduler 10b includes, on the output side of the matrix 13, multi-stage (three stages in the example illustrated in FIG. 14) FFs 12, decoders 18, OR gates 15, and a Consumer Wakeup Latency Table 22. The multi-stage FFs 12, the decoders 18, and the OR gates 15 on the input side collectively function as a first latency selector 17a, and the multi-stage FFs 12, the decoders 18, and the OR gates 15 on the output side collectively function as a second latency selector 17b.

The wakeup latency from P_{C} on the input side is assumed to be W_{S} (=2). The wakeup latency from P_{C} to C_{FMA} on the output side is assumed to be W₀ (=0) and accordingly, the wakeup latency of W_{S}+W₀=W_{S} is satisfied in total. On the other hand, the wakeup latency from P_{C} to C_{MUL} on the output side is assumed to be the shortage W_{X}=W_{L}−W_{S} (=3) and accordingly, the wakeup latency of W_{S}+W_{X}=W_{L} is satisfied in total. In this way, by supplementing the shortage of the input side by the output side, it is possible to carry out wakeup operation from the same producer at different latencies for respective consumers.

This configuration deals with such different latencies by adding the latency selector 17b on the output side with an order of circuit area and energy consumption of O(Q¹) while the main body of the matrix with an order of circuit area and energy consumption of O(Q²) is unchanged. In the matrix scheduler 10 of the multi-column scheme or the matrix scheduler 10a of the multi-bank scheme, the main body of a matrix with Q(Q²) is doubled. Here, the letter Q represents the instruction queue size, i.e., the maximum number of instructions in the scheduler.

On the other hand, a single-column scheme is unable to fully specify the latencies, and a penalty may occur for correct operation. In order to set the latency from P_{C} to C_{FMA} to W_{S}, the latency on the P_{C} side has to be set to W_{S} (W₀ on the C_{FMA} side). Furthermore, in order to set the latency from P_{C} to C_{MUL} to W_{S}+W_{X}=W_{L}, the latency on the C_{MUL} side has to be set to W_{X}. Consequently, the latency from P_{A} to C_{MUL} becomes W_{L}+W_{X}, and accordingly the penalty that the latency becomes further longer than W_{L} by W_{X} occurs. However, the probability of such a situation does not seem to be high.

### (B-2) Approach for Setting Wakeup Latency Hereinafter, description will now be made in relation to an approach for setting a Producer Wakeup Latency Table (p-WLT) and a Consumer Wakeup Latency Table (c-WLT) in the single-column scheme. In selecting a wakeup latency, a p-WLT entry wP specifies W_{L} or W_{S} on the input side and a c-WLT entry wC specifies W₀ or W_{X} on the output side. The entries wP and wC are directly connected to the latency selectors 17a and 17b on the input side and output side, respectively.

The basic rule for setting the p/c-WLTs is that, at least one p-WLT entry of a producer of a long-latency source operand set to W_{S} is present, the c-WLT entry is set to W_{X}.

The c-WLT guarantees correct execution, and the correct execution result can be obtained regardless of the p-WLT only if the above basic rule is followed. In contrast, the p-WLT affects the performance.

In the example illustrated in FIG. 14, the producers of rL1=A and rL2=C of the C_{MUL} are P_{A} and P_{C}, respectively. Since a wP entry whose value is W_{S} is present in the relationship wP[P_{C}]=W_{S}, the relationship wC[C_{MUL}]=W_{X} is assumed. On the other hand, the producer of rL1=A and rL2=A of C_{FMA} is only P_{A}, and the above rule is not held for the relationship wP[PA]=W_{L}. Although wP[P_{C}]=W_{S}, rS1=C is not a long-latency source operand and is not therefore referred to according to the rule. Consequently, WC[C_{FMA}]=W_{X} is not set, but W₀ is set.

In principle, it is assumed that the p-WLT entry of the producer for a short-latency source operand of the consumer is set to W_{S}. However, when the producer reaches the stage where the p-WLT entry is set, the consumer may not be present even in the core. Thus, at the time of setting the p-WLT, it is not known whether the consumer will receive the p-WLT via a short-latency source operand, and the producer is unable to determine W_{L} or W_{S}.

For the above, the following two-stage process may be carried out. In the first stage, the producer predicts W_{L} or W_{S} in a similar way to the branch prediction. In the second stage, the consumer makes adjustment. The second stage may be omitted, and only the first stage functions correctly but with performance degradation.

The producer predicts its W_{L} or W_{S} and makes the initial setting of the p-WLT when it is dispatched to the scheduler.

The prediction may be performed by a history-based predictor like branch prediction or the like. A predictor posteriorly learns a more efficient value and refers it for the subsequent times.

Examples of an approach without a predictor may be an approach that predicts constantly fixed one (so called always prediction), and an approach depending on the types of instructions.

In particular, always prediction that fixedly predicts W_{L} corresponds to disabling the functions to deal with the heterogeneous latencies.

An example of the approach depending of the types of instructions is to differentiate two types of FMA instructions in Arm SVE instruction set. Since an FMAD instruction executes rL1=rL1×rL2+rS1, the cumulative product is assumed and W_{L} can be predicted. On the other hand, since an FMLA instruction executes rs1=rL1×rL2+rS1, the cumulative sum is assumed and W_{S} can be predicted.

As mentioned above, in order to obtain W₀ or W_{X}, it is sufficient to simply obey the basic rule. That is, if at least one producer of a long-latency source operand set to W_{S} is present, W_{X} is set.

Whether a producer of a long-latency operand set to W_{S} is present may be obtained by referring to the following tables. The first scheme obtains the presence or the absence on the basis of the register number by referring to the register renaming table referred by the instruction decoder and register renaming unit 62. The second scheme obtains the presence or the absence on the basis of the instruction number via the p-WLT itself.

When W_{L} or W_{S} of the producers of long-latency source operands are to be obtained by using the RMT, the entries of the RMT are extended with wP field, and W_{L} or W_{S} are obtained simultaneously with register renaming.

The producers obtain their own W_{L} or W_{S} based on the prediction and write the obtained W_{L} or W_{S} into the wP fields of the destination of the RMT. The consumers read the wP fields of the sources of the RMT to obtain W_{L} or W_{S} of the producers and determine their own W₀ or W_{X}. If writing and reading are simultaneously carried out into the same register number, the bypass that the RMT originally has functions as well.

During dispatching, W_{L} or W_{S} are written into the p-WLT, and W₀ or W_{X} are written into the c-WLT.

### (B-3) Adjustment by Consumer

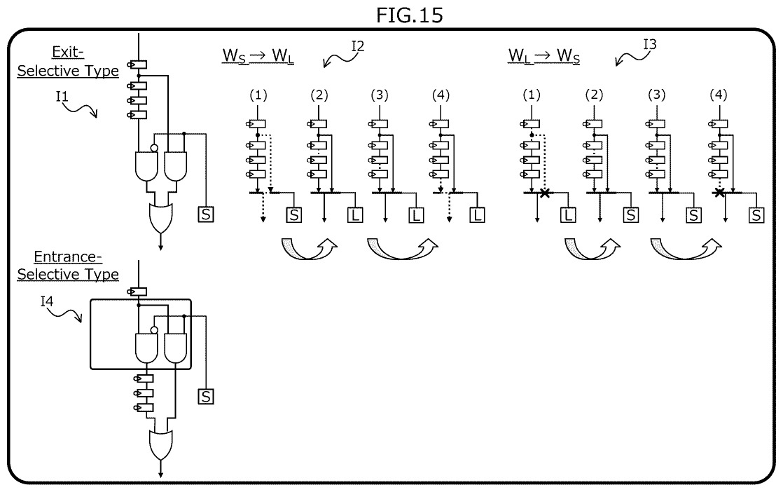

FIG. 15 is a diagram illustrating an example of a latency selector.

The reference sign I1 illustrates a latency selector of an exit-selective type. The latency selector of an exit-selective type selects a latency by selecting a path by a selector provided at the merging point.

In the latency selector of an exit-selective type illustrated in the reference sign I2, (1) after a signal passes at a latency W_{S}, (2) the latency is selected to W_{L}, (3) the FFs comes into a state of (3), and (4) wakeup occurs again.

In the latency selector of an exit-selective type illustrated in the reference sign I3, (1) after a signal passes the branch at a latency W_{S}, (2) the latency is selected to W_{S}, (3) the FFs comes into a state of (3), and (4) the signal disappears.

The reference sign I4 illustrates a latency selector of an entrance-selective type, in which the circumstances indicated by the reference numbers I2 and I3 do not occur. A latency selector of an entrance-selective type branches a signal to multiple paths by a decoder (represented by a square frame in the drawing) provided at the branch point, and merges the branched signal by the OR gate. The latency selectors 17a and 17b of FIG. 14 are also of an entrance-selective type.

Considering timings of writing and reading the p-WLT in light of the above-described basic rule, a circumstance where a wakeup signal passes through at a latency Wp=W_{S} and also the consumer reads Wp=W_{L} (and writes the result wC=W₀) is not allowed to occur.

Adjustment has the following hazard which, if a cycle that satisfies wP=W_{S} is present, the entry is not allowed to be adjusted to wP=W_{L}, and if a preceding instruction has been adjusted to wP=W_{L}, the subsequent instruction is not allowed to adjust the entry to wP=W_{S}, again.

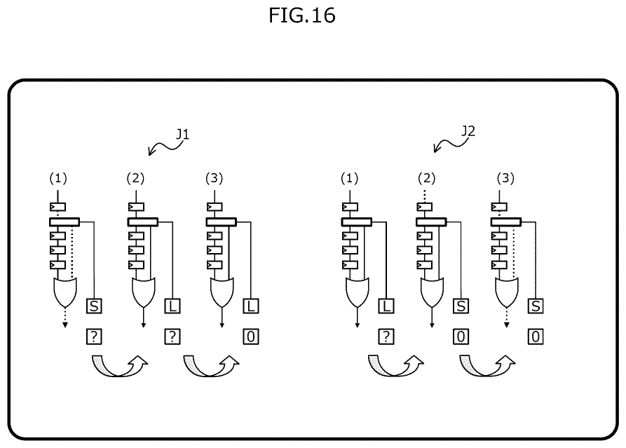

FIG. 16 is a diagram illustrating a hazard of a p-WLT entry.

In the example illustrated in the reference sign J1, (1) after a signal passes at a latency W_{S}, (2) the latency is selected to W_{L}, and (3) W₀ is written and the instruction is immediately woken up.

In the example illustrated in the reference sign J2, if (1) the preceding instruction adjusts the latency to W_{L} and (2) then the subsequent instruction adjusts W_{L} to W_{S} again, (3) the preceding instruction is woken up at the latency of W_{S}+W₀.

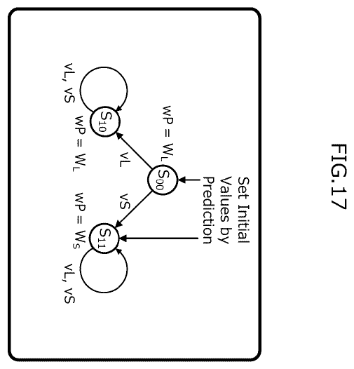

To deal with such hazards, each entry of the p-WLT may be implemented as a state machine. FIG. 17 is a diagram illustrating a design of a state machine of a p-WLT entry.

As illustrated in FIG. 17, the transition from W_{L} to W_{S} is a transition only from the initial state, and is, for example, a transition of only the consumer in the first rL. The wakeup latency W_{S} is not transited to W_{L}.

In summary, the producer obtains the initial values of its W_{L} or W_{S} by prediction prior to dispatching. In the dispatching, the producer initially sets its wP based on prediction in the p-WLT initial setting and modifies the wP of the producer. After that, the wP of the producer is further read in the p-WLT reading, and W₀ or W_{X} obtained according to the basic rule are written to the wC.

### (C) Effect

The first latency selector 17a is disposed on an input side of each column corresponding to the producer in a matrix. The second latency selector 17b is disposed on an output side of each row corresponding to a consumer in the matrix. The matrix scheduler 10b carries out wakeup operation at a latency being a sum of a latency of the first latency selector 17a through which a wakeup signal path passes and a latency of the second latency selector 17b through which the wakeup signal path further passes.

Consequently, a matrix scheduler, which is one of the highly efficient implementing schemes for an instruction scheduler, can deal with heterogeneous latencies executing unit including source operands having respective different latencies.

The matrix scheduler 10 carries out wakeup operation for the same consumer at latencies different with the multiple producers by preparing multiple columns for each of producers of the matrix.

The matrix scheduler 10a includes multiple matrices, and carries out operation for the same consumer at latencies different with the multiple producers by using a different matrix among the multiple matrices with producers.

The matrix scheduler 10b carries out wakeup operation at a latency being a sum of a latency of the first latency selector 17a through which a wakeup signal passes and a latency of the second latency selector 17b through which the wakeup signal further passes. This can suppress increase in circuit area and in energy consumption as compared with the matrix schedulers 10 and 10a.

In the matrix scheduler 10b, the producer sets a wakeup latency without referring to information of the consumer. The matrix scheduler 10b sets the wakeup latency using a predictor. The matrix scheduler 10b sets the wakeup latency based on the type of producer instruction. The matrix scheduler 10b includes a first table for setting a latency of the first latency selector and a second table for setting a latency of the second latency selector, and supplements a latency shortage that is insufficient in a setting value of the first table with a setting value of the second table. The matrix scheduler 10b may obtain the setting value of the second table concurrently with register renaming by storing the setting value of the first table into a register renaming table. The matrix scheduler 10b obtains the setting value of the first table for obtaining the setting value of the second table by reading the first table. In the matrix scheduler 10b, the consumer adjusts the setting value of the first table. When the consumer adjusts the setting value of the first table, the matrix scheduler 10b adjusts the setting value not in the direction that prolongs the latency. Accordingly, the latency can be appropriately set.

### (D) Miscellaneous

The disclosed techniques are not limited to the embodiment described above, and may be variously modified without departing from the scope of the present embodiment. The respective configurations and processes of the present embodiment can be selected, omitted, and combined according to the requirement.

If the performance degradation caused by needless compensation wakeup latency is significant, the matrix scheduler may switch to a mode that does not cope with heterogeneous latencies. For example, the prediction target is fixed to always W_{L} in the prediction.

In one aspect, a matrix scheduler can deal with heterogeneous latencies executing unit including source operands having respective different latencies.

Throughout the descriptions, the indefinite article “a” or “an”, or adjective “one” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A processor comprising a matrix scheduler, wherein
the matrix scheduler comprises
a first latency selector disposed on an input side of each column corresponding to a producer in a matrix; and
a second latency selector disposed on an output side of each row corresponding to a consumer in the matrix, and
the matrix scheduler is configured to carry out wakeup operation at a latency being a sum of a latency of the first latency selector and a latency of the second latency selector on a wakeup signal path passing through the first latency selector and further passing through the second latency selector.

2. A processor comprising a matrix scheduler,
the matrix scheduler being configured to:
comprise a plurality of columns for each of a plurality of producers in a matrix;
carry out wakeup operation for a same consumer at latencies different with the plurality of producers.

3. A processor comprising a matrix scheduler,
the matrix scheduler comprising a plurality of matrices and being configured to
carry out wakeup operation for a same consumer at latencies different with producers by using a different matrix among the plurality of matrix with the producers.

4. The processor according to claim 1, wherein
the producer sets a wakeup latency without referring to information of the consumer.

5. The processor according to claim 4, wherein
the matrix scheduler sets the wakeup latency using a predictor.

6. The processor according to claim 4, wherein
the matrix scheduler sets the wakeup latency based on a type of the producer.

7. The processor according to claim 1, further comprising
a first table that sets a latency of the first latency selector and a second table that sets a latency of the second latency selector, wherein
a latency shortage in a setting value of the first table is supplemented by a setting value of the second table.

8. The processor according to claim 7, wherein
the setting value of the second table is obtained concurrently with register renaming by storing the setting value of the first table into a register renaming table.

9. The processor according to claim 7, wherein
the setting value of the first table for obtaining the setting value of the second table is obtained by reading the first table.

10. The processor according to claim 7, wherein
the consumer adjusts the setting value of the first table.

11. The processor according to claim 10, wherein
the consumer adjusts the setting value of the first table not in a direction that prolongs the latency.

12. The processor according to claim 1, further comprising:
a plurality of paths each including zero- or more-stage flip-flops; and
a decoder disposed at a branch point of the plurality of paths, wherein
the latency is selected by selecting one of the plurality paths by the decoder.

13. An information processing device, wherein
the matrix scheduler comprises
a first latency selector disposed on an input side of each column corresponding to a producer in a matrix; and
a second latency selector disposed on an output side of each row corresponding to a consumer in the matrix, and
an instruction carries out wakeup operation at two or more latency different with columns of the matrix by summing a latency of the first latency selector and a latency of the second latency selector on a wakeup signal path passing through the first latency selector and further passing through the second latency selector.

14. An information processing device comprising a matrix scheduler,
the matrix scheduler being configured to:
comprise a plurality of columns for each of a plurality of producers in a matrix;
carry out wakeup operation for a same consumer at latencies different with the plurality of producers.

15. An information processing device comprising a matrix scheduler,
the matrix scheduler comprising a plurality of matrices and being configured to
carry out wakeup operation for a same consumer at latencies different with producers by using a different matrix among the plurality of matrix with the producers.

16. The information processing device according to claim 13, wherein
the producer sets a wakeup latency without referring to information of the consumer.

17. The information processing device according to claim 16, wherein
the matrix scheduler sets the wakeup latency based on a type of the producer.

18. The information processing device according to claim 16, wherein
the matrix scheduler sets the wakeup latency based on a type of producer instruction.

19. The information processing device according to claim 13, further comprising
a first table that sets a latency of the first latency selector and a second table that sets a latency of the second latency selector, wherein
a latency shortage in a setting value of the first table is supplemented by a setting value of the second table.

20. The information processing device according to claim 19, wherein
the setting value of the second table is obtained concurrently with register renaming by storing the setting value of the first table into a register renaming table.
